(19) United States
(12) Patent Application Publication
(10) Pub. No.: US 2021/0361017 A1
(43) Pub. Date: Nov. 25, 2021

(54) Infrared Motorcycle Helmet Device

(71) Applicant: Nathan Mooney, Long Lane, MO (US)

(72) Inventor: Nathan Mooney, Long Lane, MO (US)

(21) Appl. No.: 17/325,850

(22) Filed: May 20, 2021

Related U.S. Application Data
(60) Provisional application No. 63/027,771, filed on May 20, 2020.

(51) Int. Cl. A42B 3/04; A42B 3/30

(52) U.S. Cl. CPC A42B 3/042; A42B 3/30; A42B 3/0453; A42B 3/046

(57) ABSTRACT

An infrared motorcycle helmet device is provided. The infrared motorcycle helmet device includes a helmet. The helmet has an opening on a front portion of the helmet. An external visor is placed on an external surface of the helmets. The external visor can be moved into a position over the opening as desired. An infrared camera is placed on an external surface of the helmet.

### CROSS REFERENCE TO RELATED APPLICATIONS

This application claims the benefit of U.S. Provisional Application No. 63/027,771 filed on May 20, 2020. The above identified patent application is herein incorporated by reference in its entirety to provide continuity of disclosure.

### BACKGROUND OF THE INVENTION

The present invention relates to an infrared motorcycle helmet device. Specifically, the present invention provides a system for detecting heat signatures while a user is operating a motorcycle or similar device.

Many individuals travel down roadways on motorcycles in low light conditions. When traveling at speed, it can be hard to see animals or people on the side of the roadway. Particularly, animals may naturally blend into their surroundings due to naturally evolved camouflage. Some animals wander into roadways and may cause great harm to vehicles and their occupants in the event of a collision. These risks are particularly grave for motorcyclists who have less protection than typical automobile operators, particular when operating a motorcycle at night.

Therefore, there is a defined need amongst the known prior art references for a device that provides enhanced vision and safety to motorcycle operators. The device will ideally be utilized for night driving situations and will be designed to detect infrared heat signatures to alert the driving to the presence of pedestrians or animals.

### SUMMARY OF THE INVENTION

In view of the foregoing disadvantages inherent in the known types of motorcycle safety helmets now present in the prior art, the present, invention provides an infrared motorcycle helmet device wherein the same can be utilized for providing convenience for the user when protecting a motorcyclist from striking pedestrians or animals.

The present system comprises a helmet. The helmet defines an opening on a front portion thereof. Furthermore, the helmet comprises an external visor. The external visor is rotatably mounted on an external surface of the front portion of the helmet. The external visor is movable over the opening of the helmet, such as to prevent air flow therethrough. An infrared camera is disposed on the external surface of the helmet.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the infrared motorcycle helmet device.

FIG. 2 shows a perspective view of an embodiment of the infrared motorcycle helmet device in use.

FIG. 3 shows a block diagram of an embodiment of the infrared motorcycle helmet device.

FIG. 4 shows a demonstrative view of an embodiment of the heads up display (HUD) of the infrared motorcycle helmet device.

### DETAILED DESCRIPTION OF THE INVENTION

Reference is made herein to the attached drawings. Like reference numerals are used throughout the drawings to depict like or similar elements of the infrared motorcycle helmet device. The figures are intended for representative purposes only and should not be considered to be limiting in any respect.

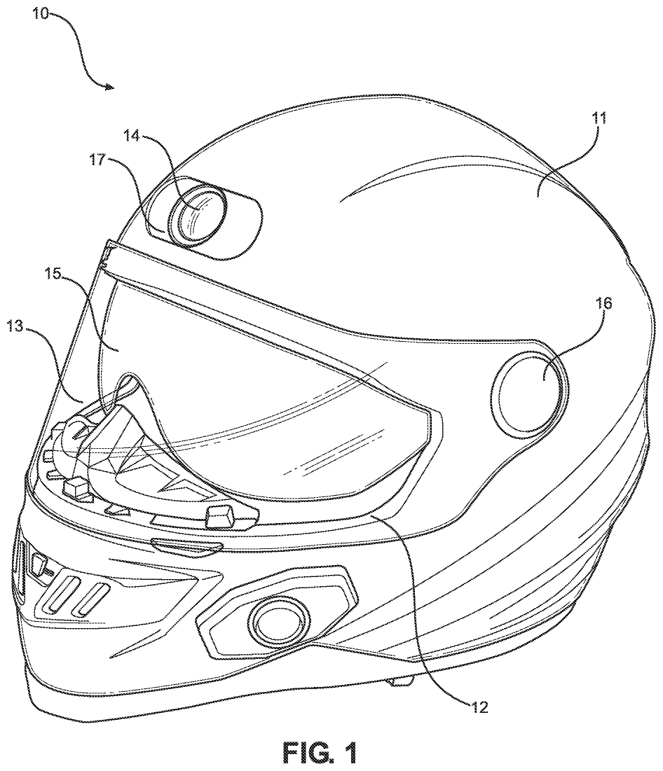

Referring now to FIG. 1, there is shown a perspective view of an embodiment of the infrared motorcycle helmet device. The infrared motorcycle helmet device 10 comprises a helmet 11. The helmet 11 defines an opening 12. The opening 12 is disposed on a front portion of the helmet 11. The opening 12 is positioned to correspond to the eyes of the wearer, such that the user may see through the opening 12 while wearing the helmet 11. The front portion of the helmet 11 is defined as the portion of the helmet 11 corresponding to the face of the wearer.

The infrared motorcycle helmet device 10 further comprises an external visor 13. The external visor 13 is mounted on an external surface of the helmet 11, on the front portion thereof. The external visor 13 is movable over the opening of the helmet 11. As such, the external visor 13 may be utilized to shield the wearer from air currents or particles in the air. The external visor 13, in the illustrated embodiment, is connected to the helmet 11 by a pair of pivots 16 disposed on a pair of opposing sides of the helmet 11. In some embodiments, the external visor 13 is removable from the helmet 11. As such, the user will be able to clean the helmet 11 and the external visor 13 easier.

An infrared camera 14 is disposed on the external surface of the helmet 11. The infrared camera 14 is of any suitable configuration for capturing infrared images. Structurally, the infrared camera 14 may comprise a lens, a processor, a power unit and a storage unit. As such, the infrared camera 14 is relatively elevated relative to the eyes of the wearer. Such placement will provide a greater field of view relative to a lower elevated position. In some embodiments, the infrared camera 14 comprises a fisheye lens. As such, a greater field of view will be provided by the infrared camera 14.

In the illustrated embodiment, the infrared camera 14 is centrally disposed above the external visor 13 on the front portion of the helmet 11. Furthermore, in the illustrated embodiment, the infrared camera 14 is inset into the helmet 11. Specifically, the infrared camera 14 is disposed in a cavity 17 formed into the helmet 11. By making the infrared camera 14 inset into the helmet 11, the infrared motorcycle helmet device 10 will remain aerodynamic.

In the illustrated embodiment, the helmet further comprises an internal visor 15. The internal visor 15 is disposed on an area within the opening 12. Furthermore, the internal visor 15 is disposed underneath the external visor 13. The internal visor 15 may be tinted, such as to shield the eyes of the user from the sun or other bright light sources.

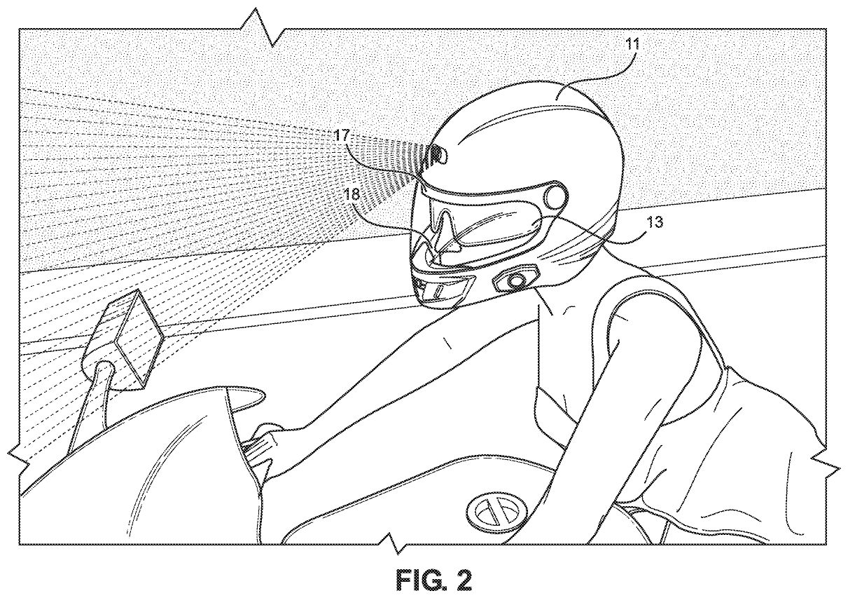

Referring now to FIG. 2, there is shown a perspective view of an embodiment of the infrared motorcycle helmet device in use. In the illustrated embodiment, the external visor 13 comprises an upper portion 17 and a lower portion 18. In the demonstrated embodiment, the lower portion 18 of the external visor 13 is transparent, such as to enable normal visibility through the external visor 13. Furthermore, in the demonstrated embodiment, the upper portion 17 of the external visor 13 comprises a heads-up display (HUD). The heads-up display (HUD) is shown and described in FIG. 4.

In one embodiment, the upper portion 17 of the external visor 13 comprises a connection interface with the infrared camera 14. As such, when the external visor 13 is placed into the closed position, contact between the external visor 13 and a designated portion of the helmet 11 causes the heads-up display to be actuated on the external visor 13. The heads-up display may also be actuated by some other mechanism, such as a button, a switch, or a motion sensor that senses the head of the user tilting forward.

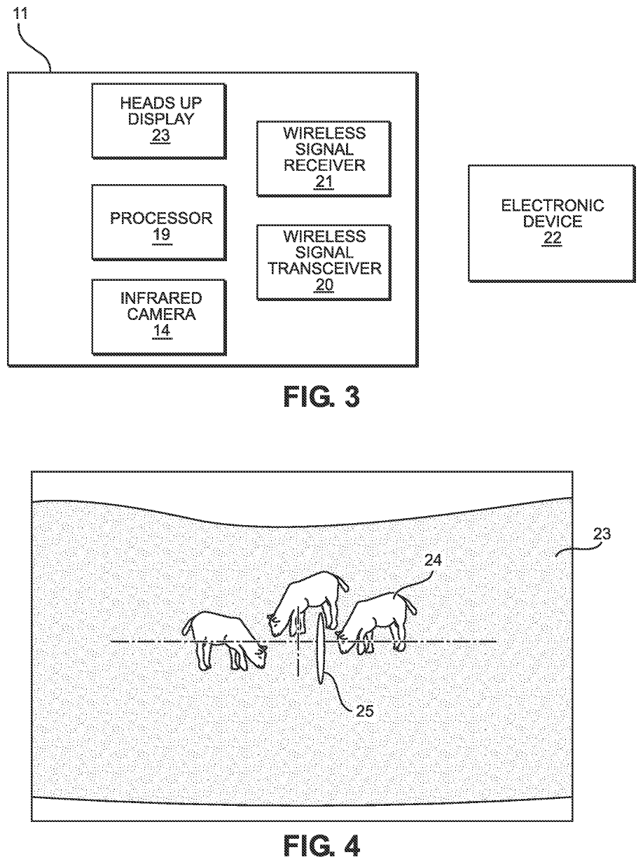

Referring now to FIG. 3, there is shown a block diagram of an embodiment of the infrared motorcycle helmet device. In the illustrated embodiment, the helmet 11 further comprises a processor 19. The processor 19 is in operable connection with the infrared camera 14, such that the image dat3 gathered by the infrared camera 14 may be modified, translated, displayed or otherwise acted upon by the processor 19. As such the processor 19 is also in operable connection with the heads up display (HUD) 23, such that the image data from the infrared camera 14 can be presented upon the heads up display (HUD) 23.

Furthermore, in the illustrated embodiment, the processor 19 is in operable connection with a wireless signal transceiver 20 and a wireless signal receiver 21. The wireless signal transceiver 20 is configured to transmit data wirelessly, while the wireless signal receiver 21 is configured to receive data wirelessly. As such, the processor 19 will be able to communicate with an external electronic device 22. The external electronic device 22 may be a cellular phone or similar device, in which case a wireless connection can allow for phone calls to be made from the electronic device 22.

Referring now to FIG. 4, there is shown a demonstrative view of an embodiment of the heads up display (HUD) of the infrared motorcycle helmet device, in the illustrated embodiment, the heads up display (HUD) 23 comprises a visual overlay 25 of heat signatures gathered from heat-producing objects 24, such as animals or pedestrians. In the illustrated embodiment, the visual overlay 25 is a simple shape, however, in alternate embodiments, the visual overlay 25 may vary based on the heat-producing object 24.

It is therefore submitted that the instant invention has been shown and described in various embodiments, it is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not. desired to limit, the invention to the exact, construction and operation shown and described, and accordingly, all suitable modifications and equivalents may be resorted to, falling within the scope of the invention.

I claim:

1) An infrared motorcycle helmet device, comprising:
a helmet;
the helmet defining an opening on a front portion of the helmet;
an external visor mounted on an external surface of the helmet;
the external visor movable over the opening;
an infrared camera disposed on the external surface of the helmet.

2) The infrared motorcycle helmet device of claim 1, further comprising an internal visor disposed over the opening, underneath the external visor.

3) The infrared motorcycle helmet device of claim 1, wherein the external visor is affixed by a pair of pivots disposed on a pair of opposing sides of the helmet.

4) The infrared motorcycle helmet device of claim 1, wherein the external visor is removable from the helmet.

5) The infrared motorcycle helmet device of claim 1, wherein the infrared camera is centrally disposed on a front portion of the helmet.

6) The infrared motorcycle helmet device of claim 1, wherein the infrared camera comprises a fisheye lens.

7) The infrared motorcycle helmet device of claim 1, wherein the infrared camera is inset into the helmet.

8) The infrared motorcycle helmet device of claim 1, wherein the external visor comprises an upper portion and a lower portion.

9) The infrared motorcycle helmet device of claim 8, wherein the lower portion of the external visor is transparent.

10) The infrared motorcycle helmet device of claim 8, wherein the upper portion of the external visor comprises a heads-up display.

11) The infrared motorcycle helmet device of claim 1, wherein the helmet comprises a processor, the processor in operable connection with a wireless signal receiver and a wireless signal transceiver.
